(19) United States
(12) Patent Application Publication
(10) Pub. No.: US 2025/0252019 A1
(43) Pub. Date: Aug. 7, 2025

(54) INFORMATION PROCESSING SYSTEM AND NON-TRANSITORY COMPUTER-READABLE STORAGE MEDIUM

(71) Applicant: FUJIFILM Business Innovation Corp., Tokyo (JP)

(72) Inventor: Manabu WADA, Kanagawa (JP)

(73) Assignee: FUJIFILM Business Innovation Corp., Tokyo (JP)

(21) Appl. No.: 18/785,967

(22) Filed: Jul. 26, 2024

(30) Foreign Application Priority Data
Feb. 2, 2024 (JP) 2024-015187

(51) Int. Cl. G06F 11/14

(52) U.S. Cl. CPC G06F 11/1433; G06F 11/1438

(57) ABSTRACT

An information processing system includes a processor, in which the processor: records information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed; activates installer software for performing the recovery processing in a state where the controller software is not activated and executes the recovery processing via the installer software; and activates the controller software after executing the recovery processing, and when the firmware of the functional device is normal and the information indicating that the recovery processing is to be executed has been recorded in the storage unit, records, in a log, via the controller software, that the recovery processing has been executed and that the recovery processing has succeeded.

### CROSS-REFERENCE TO RELATED APPLICATIONS

This application is based on and claims priority under 35 USC 119 from Japanese Patent Application No. 2024-015187 filed Feb. 2, 2024.

### BACKGROUND

### (i) Technical Field

The present disclosure relates to an information processing system and a non-transitory computer-readable storage medium.

### (ii) Related Art

JP2022-157063A discloses an information processing apparatus that performs falsification detection and recovery through software verification allowing the recovered information processing apparatus to be used securely even when a copy of the software used in the recovery cannot be updated.

JP2004-318871A discloses a communication apparatus and a remote management system for the communication apparatus wherein when an OS for update is downloaded from an external apparatus such as a management apparatus to update the OS and the update fails due to power interruption or the like, the failure can be easily and reliably determined at the time of restart with subsequent power input.

### SUMMARY

For example, in an information processing system that performs firmware recovery processing when firmware installed in a functional device such as a facsimile card is falsified, there is a demand for recording an execution result of the recovery processing in a log.

However, when the recovery processing is performed, the controller software for controlling the functional device and recording a log related to the functional device is not activated, and only the installer software for performing the recovery processing is activated. Therefore, there is a problem that the execution result of the recovery processing cannot be recorded in the log.

Aspects of non-limiting embodiments of the present disclosure relate to an information processing system and a non-transitory computer-readable storage medium capable of recording an execution result of recovery processing in a log in the information processing system that performs the recovery processing of firmware when the firmware installed in a functional device is falsified.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor, wherein the processor: records information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed; activates installer software for performing the recovery processing in a state where the controller software is not activated and executes the recovery processing via the installer software; and activates the controller software after executing the recovery processing, and when the firmware of the functional device is normal and the information indicating that the recovery processing is to be executed has been recorded in the storage unit, records, in a log, via the controller software, that the recovery processing has been executed and that the recovery processing has succeeded.

### BRIEF DESCRIPTION OF THE DRAWINGS

Exemplary embodiments of the present invention will be described in detail based on the following figures, wherein:

FIG. 1 is an external view of an image forming apparatus according to an exemplary embodiment of the present disclosure;

FIG. 2 is a block diagram illustrating a hardware configuration of the image forming apparatus;

FIG. 3 is a block diagram illustrating a functional configuration of the image forming apparatus;

FIG. 4 is a diagram for describing a software configuration of the image forming apparatus at the time of normal activation;

FIG. 5 is a diagram for describing a software configuration of the image forming apparatus at the time of firmware installation;

FIG. 6 is a former half of a sequence diagram illustrating a flow of processing at the time of facsimile card verification in the image forming apparatus; and

FIG. 7 is a latter half of the sequence diagram illustrating a flow of processing at the time of facsimile card verification in the image forming apparatus.

### DETAILED DESCRIPTION

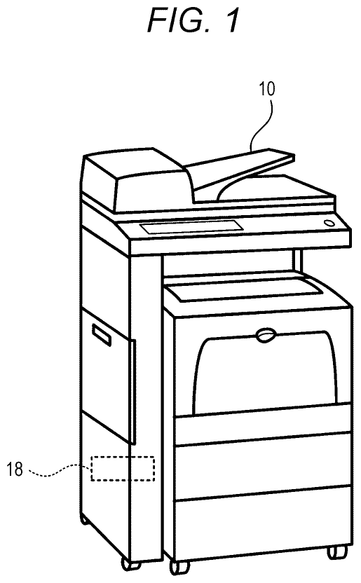

Hereinafter, an exemplary embodiment of the present disclosure will be described in detail with reference to the drawings. FIG. 1 is an external view of an image forming apparatus according to an exemplary embodiment of the present disclosure.

As illustrated in FIG. 1, an image forming apparatus 10 is a so-called multifunction machine having a plurality of functions such as a printing function, a scanning function, a copying function, and a facsimile function. The image forming apparatus 10 is an example of an information processing system in the technology of the present disclosure.

As illustrated in FIG. 1, the image forming apparatus 10 includes a facsimile card 18. The facsimile card 18 is a device mounted on the image forming apparatus 10 to provide the image forming apparatus 10 with a facsimile function. The facsimile card 18 is an example of a functional device in the technology of the present disclosure.

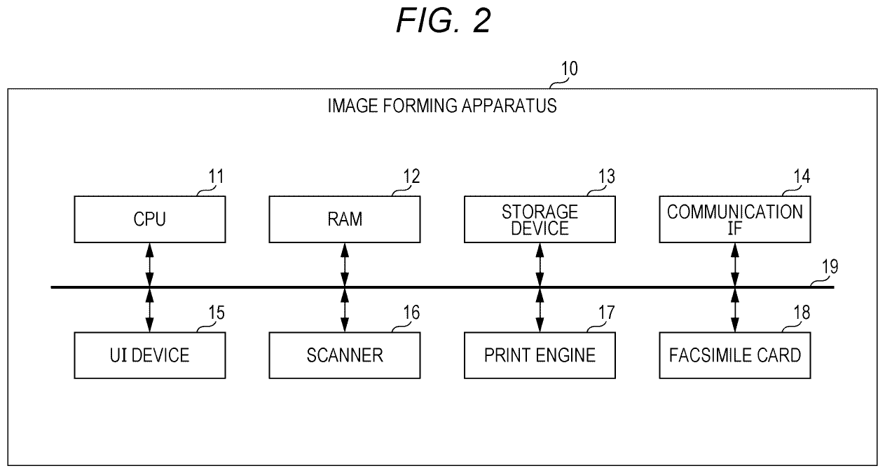

Next, the hardware configuration of the image forming apparatus 10 according to the present exemplary embodiment will be described. FIG. 2 is a block diagram illustrating a hardware configuration of the image forming apparatus 10.

As illustrated in FIG. 2, the image forming apparatus 10 includes a central processing unit (CPU) 11, a random access memory (RAM) 12, a storage device 13 such as a hard disk drive, a communication interface (abbreviated as IF) 14, a user interface (abbreviated as UI) device 15 including a touch panel or a liquid crystal display and a keyboard, a scanner 16, a print engine 17, and the facsimile card 18. These components are connected to each other via a control bus 19.

The CPU 11 is a processor that executes predetermined processing based on a control program stored in the RAM 12 or the storage device 13 to control the operation of the image forming apparatus 10. In the description of the present exemplary embodiment, the CPU 11 reads and executes the control program stored in the RAM 12 or the storage device 13, but the present disclosure is not limited to this configuration. The control program may be provided in a form of being recorded in a computer-readable recording medium. For example, the program may be provided in a form of being recorded on an optical disc such as a compact disc (CD)-read only memory (ROM) and a digital versatile disc (DVD)-ROM, or in a form of being recorded on a semiconductor memory such as a universal serial bus (USB) memory and a memory card. The control program may be acquired from an external device via a communication line connected to the communication IF 14.

The communication IF 14 performs data transmission and reception with an external device or the like. The UI device 15 receives an instruction input from a user. The scanner 16 reads a document loaded in the image forming apparatus 10 as image data. The print engine 17 prints an image on a recording medium, such as a printing paper, through steps such as charging, exposure, development, transfer, and fixing. The facsimile card 18 performs facsimile communication between the image forming apparatus 10 and an external device based on control by installed firmware.

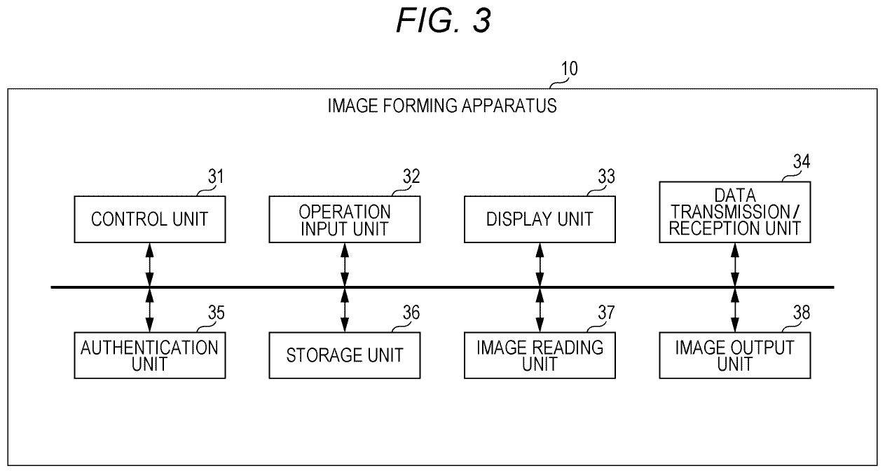

Next, the functional configuration of the image forming apparatus 10 according to the present exemplary embodiment will be described. FIG. 3 is a block diagram illustrating a functional configuration of the image forming apparatus 10.

As illustrated in FIG. 3, the image forming apparatus 10 of the present exemplary embodiment includes a control unit 31, an operation input unit 32, a display unit 33, a data transmission/reception unit 34, an authentication unit 35, a storage unit 36, an image reading unit 37, and an image output unit 38.

The control unit 31 controls the overall operation of the image forming apparatus 10, and for example, based on an instruction input from the user, performs control of communicating with an external device with the data transmission/reception unit 34, control of reading a document image with the image reading unit 37, control of outputting print data from the image output unit 38, and the like.

The operation input unit 32 inputs information of various operations performed by the user. The display unit 33 is controlled by the control unit 31 and displays various information to the user. The data transmission/reception unit 34 transmits and receives data to and from an external device via facsimile communication or Internet communication. The authentication unit 35 executes authentication processing for a user who attempts to use the image forming apparatus 10.

The storage unit 36 stores various kinds of data such as a control program for controlling the operation of the image forming apparatus 10 and firmware for controlling the facsimile card 18. The image reading unit 37 reads a document image from a loaded document. The image output unit 38 outputs an image onto a recording medium such as a printing paper.

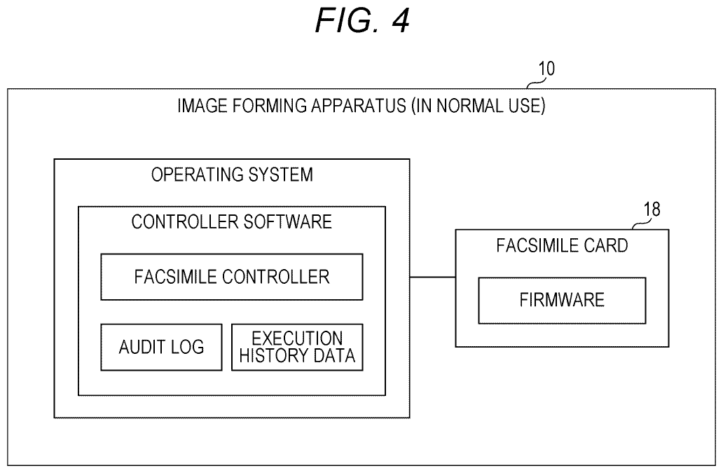

As illustrated in FIG. 4, at the time of normal activation of the image forming apparatus 10, controller software for controlling the operation of the image forming apparatus 10 is activated on the operating system of the image forming apparatus 10.

The controller software includes a facsimile controller for controlling the facsimile card 18. The facsimile controller has a function of recording the contents of processing performed in the facsimile card 18 in an audit log.

In the image forming apparatus 10, when firmware installed in the facsimile card 18 added to the image forming apparatus 10 has been falsified, it is possible to perform recovery processing for reinstalling the firmware in the facsimile card 18, but there is a demand for recording an execution result of the recovery processing in the audit log.

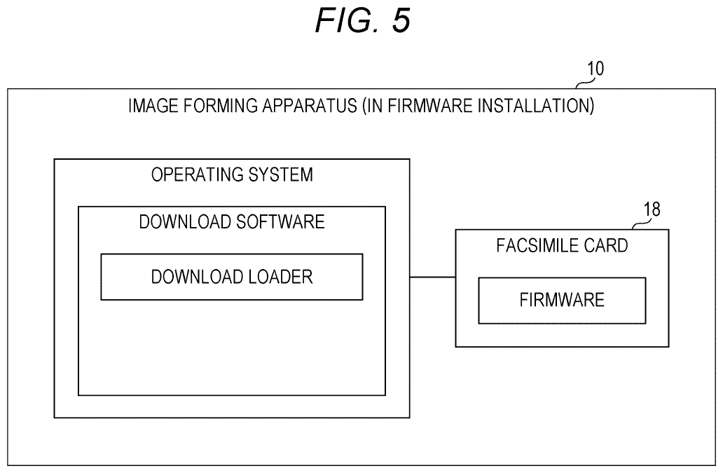

However, since a change occurs in the system when the recovery processing is performed, as illustrated in FIG. 5, the controller software is not activated, and only the installer software for performing the recovery processing is activated, in order to minimize the software activated on the operating system of the image forming apparatus 10.

In this case, since the controller software for recording an audit log is not activated, a problem arises in that the execution result of the recovery processing performed by the installer software cannot be recorded in the audit log.

To solve such a problem, the control unit 31 of the image forming apparatus 10 of the present exemplary embodiment records execution history data in the storage unit 36 via controller software when a falsification of firmware installed in the facsimile card 18 is detected in a state where the controller software has been activated, the execution history data being information indicating that recovery processing for reinstalling the firmware in the facsimile card 18 is to be executed, activates installer software in a state where the controller software is not activated and executes the recovery processing via the installer software, and activates the controller software after executing the recovery processing, and when the firmware of the facsimile card 18 is normal and the execution history data has been recorded in the storage unit 36, records, in an audit log, via the controller software, that the recovery processing has been executed and that the recovery processing has succeeded.

In the image forming apparatus 10 according to the present exemplary embodiment, the control unit 31 may execute restart of the image forming apparatus 10 after recording execution history data in the storage unit 36 via the controller software. The execution history data may be stored in the non-volatile storage unit 36 when the recovery processing involves restart of the image forming apparatus 10.

Here, when the activation of the image forming apparatus 10 immediately before the falsification of the firmware installed in the facsimile card 18 is detected is an activation through power-on of the image forming apparatus 10, the control unit 31 may execute restart of the image forming apparatus 10. When the activation of the image forming apparatus 10 immediately before the falsification of the firmware installed in the facsimile card 18 is detected is an activation through a return of the image forming apparatus 10 from a power saving state, the control unit 31 may notify the user of the restart of the image forming apparatus 10, and may execute the restart of the image forming apparatus 10 in response to an instruction from the user.

The control unit 31 may execute restart of the image forming apparatus 10 after executing recovery processing.

After the image forming apparatus 10 is restarted after the execution of the recovery processing, the control unit 31 may activate the controller software, and when the falsification of the firmware installed in the facsimile card 18 is detected and the execution history data is recorded in the storage unit 36, the control unit 31 may record, in the log via the controller software, that the recovery processing has been executed and that the recovery processing has failed.

In this case, the control unit 31 may record in the log that the recovery processing has been executed and that the recovery processing has failed, and then execute the recovery processing again.

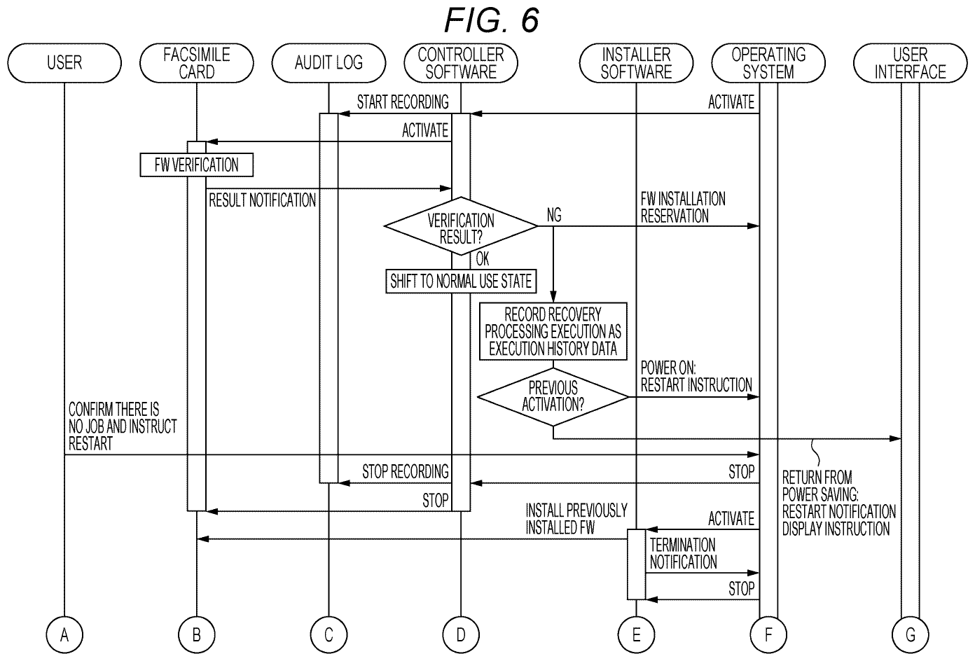

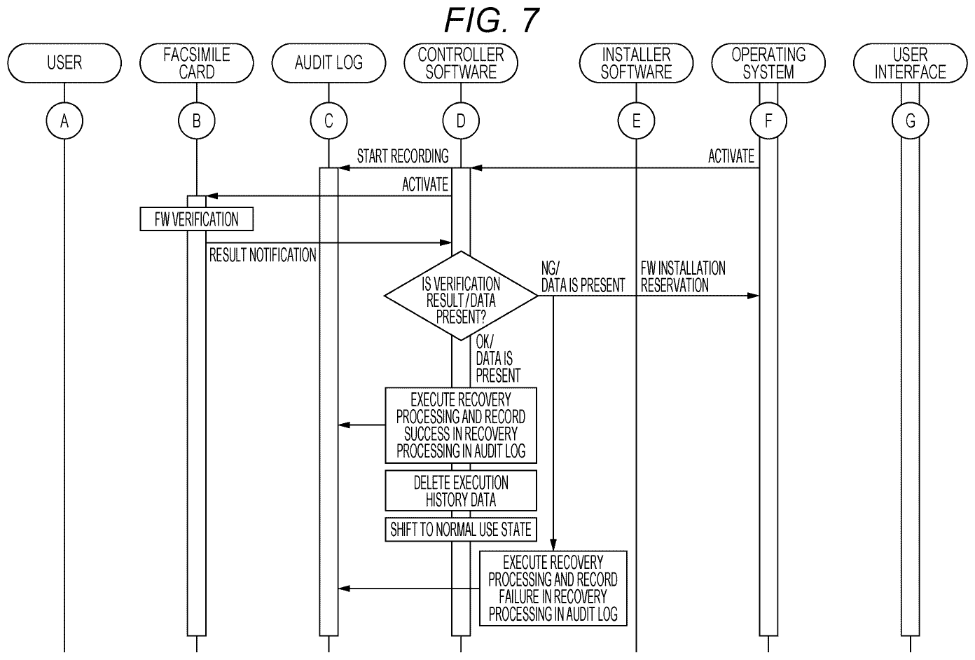

Next, a flow of processing at the time of verification of the facsimile card 18 in the image forming apparatus 10 of the present exemplary embodiment will be described with reference to the sequence diagram of FIGS. 6 and 7. FIG. 6 and FIG. 7 illustrate one sequence diagram, FIG. 6 is a former half of the sequence diagram, and FIG. 7 is a latter half of the sequence diagram. In the sequence diagram of FIGS. 6 and 7, the processing other than user processing are executed under the control of the control unit 31.

When the image forming apparatus 10 is activated, the operating system and the user interface are activated. First, the operating system activates controller software including the facsimile controller.

The controller software then initiates recording of an audit log related to the facsimile card 18 and then activates the facsimile card 18.

Next, the facsimile card 18 verifies the presence or absence of falsification of the firmware (described as FW in FIGS. 6 and 7), and notifies the verification result to the controller software.

Next, when the verification result is OK (that is, there is no falsification of the firmware), the controller software terminates the verification processing of the firmware installed in the facsimile card 18, and shifts to the normal use state.

When the verification result is NG (that is, these is a falsification of the firmware), the controller software reserves installation of the firmware of the facsimile card 18 in the operating system, and records, in the storage unit 36, execution history data that is information indicating that recovery processing of reinstalling the firmware in the facsimile card 18 is to be executed.

Next, the controller software determines whether the previous activation of the image forming apparatus 10 is an activation through power-on of the image forming apparatus 10 or an activation through a return of the image forming apparatus 10 from a power saving state, and when the previous activation of the image forming apparatus 10 is activation through power-on of the image forming apparatus 10, the controller software instructs the operating system to restart. In response to the instruction, the operating system executes restart of the image forming apparatus 10.

When the previous activation of the image forming apparatus 10 is an activation through a return of the image forming apparatus 10 from a power saving state, the controller software instructs a notification display of restart to the user interface. In response to the instruction, the user interface displays a notification requesting the user to restart the image forming apparatus 10.

When the user has confirmed the notification display on the user interface, the user confirms that there is no job being executed, and inputs an instruction of restart to the operating system. In response to the instruction, the operating system executes restart of the image forming apparatus 10.

When restart of the image forming apparatus 10 is executed, the operating system stops the controller software. When the controller software has received the stop instruction, the controller software stops recording of the audit log related to the facsimile card 18, stops the facsimile card 18, and then stops the controller software itself.

After the image forming apparatus 10 is restarted, the operating system activates only the installer software and executes the recovery processing via the installer software.

The storage unit 36 of the image forming apparatus 10 stores the firmware previously installed in the facsimile card 18. In the recovery processing, the previously installed firmware is reinstalled in the facsimile card 18.

After the restoration processing is terminated, the installer software notifies the operating system of the termination of the recovery processing. Upon receiving the notification, the operating system stops the installer software and then executes restart of the image forming apparatus 10.

When the restart of the image forming apparatus 10 is executed, the operating system and the user interface are activated. Next, the operating system activates the controller software including the facsimile controller.

The controller software then initiates recording of an audit log related to the facsimile card 18 and then activates the facsimile card 18.

Next, the facsimile card 18 verifies the presence of absence of falsification of the firmware, and notifies the controller software of the verification result.

Next, when the verification result is OK (that is, there is no falsification of the firmware) and the execution history data has been recorded in the storage unit 36, the controller software records, in the audit log, that the recovery processing has been executed and that the recovery processing has succeeded, deletes the execution history data, and then shifts to the normal use state.

When the verification result is NG (that is, these is a falsification of the firmware) and the execution history data has been recorded in the storage unit 36, the controller software reserves installation of the firmware of the facsimile card 18 in the operating system, further records, in the audit log, that the recovery processing has been executed and that the recovery processing has failed, and executes the recovery processing again.

### Modification Example

Although the information processing system according to an exemplary embodiment of the present disclosure has been described above, the technology of the present disclosure is not limited to the above-described exemplary embodiment, and can be appropriately modified.

For example, the technology of the present disclosure is not limited to the image forming apparatus 10, but may be applied to any system as long as the system records a log related to a functional device.

In the technology of the present disclosure, the “system” includes both a system configured by a plurality of devices and a system configured by a single device.

In the technology of the present disclosure, the “processor” refers to a processor in a broad sense, and it includes general-purpose processors (for example, CPU: central processing unit and the like) and dedicated processors (for example, GPU: graphics processing unit, ASIC: application specific integrated circuit, FPGA: field programmable gate array, programmable logic devices, and the like).

The operation of the processor in the technology of the present disclosure may be performed not only by one processor but also by a plurality of processors existing at physically distant positions in cooperation with each other. The order of the respective operations of the processors is not limited to only the order described in each exemplary embodiment described above but may be appropriately changed.

### [Supplementary Note]

Hereinafter, supplementary notes on preferred aspects of the present disclosure will be provided.

(((1)))

An information processing system comprising a processor,
wherein the processor:
records information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed;
activates installer software for performing the recovery processing in a state where the controller software is not activated and executes the recovery processing via the installer software; and
activates the controller software after executing the recovery processing, and when the firmware of the functional device is normal and the information indicating that the recovery processing is to be executed has been recorded in the storage unit, records, in a log, via the controller software, that the recovery processing has been executed and that the recovery processing has succeeded.
   (((2)))

The information processing system according to (((1))), wherein
the processor records, in the storage unit via the controller software, the information indicating that the recovery processing is to be executed, and then executes restart of the system.
   (((3)))

The information processing system according to (((2))), wherein
when the activation of the system immediately before the falsification of the firmware installed in the functional device is detected is an activation through power-on of the system, the processor executes restart of the system.
   (((4)))

The information processing system according to (((2))), wherein
when the activation of the system immediately before the falsification of the firmware installed in the functional device is detected is an activation through a return of the system from a power saving state, the processor notifies a user of restart of the system and executes the restart of the system in response to an instruction from the user.
   (((5)))

The information processing system according to any one of (((1)) to (((4))), wherein
the processor executes restart of the system after executing the recovery processing.
   (((6)))

The information processing system according to any one of (((5))), wherein
the processor activates the controller software after restart of the system after executing the recovery processing, and when the falsification of the firmware installed in the functional device has been detected and the information indicating that the recovery processing is to be executed has been recorded in the storage unit, records, in a log via the controller software, that the recovery processing has been executed and that the recovery processing has failed.
   (((7)))

The information processing system according to (((6))), wherein
the processor records, in the log, that the recovery processing has been executed and that the recovery processing has failed, and then executes the recovery processing again.
   (((8)))

A non-transitory computer-readable storage medium storing a program causing a computer to execute processing comprising:
recording information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed;
activating installer software for performing the recovery processing in a state where the controller software is not activated and executes the recovery processing via the installer software; and
activating the controller software after executing the recovery processing, and when the firmware of the functional device is normal and the information indicating that the recovery processing is to be executed has been recorded in the storage unit, recording, in a log, via the controller software, that the recovery processing has been executed and that the recovery processing has succeeded.

What is claimed is:

1. An information processing system comprising a processor,
wherein the processor:
records information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed;
activates installer software for performing the recovery processing in a state where the controller software is not activated and executes the recovery processing via the installer software; and
activates the controller software after executing the recovery processing, and when the firmware of the functional device is normal and the information indicating that the recovery processing is to be executed has been recorded in the storage unit, records, in a log, via the controller software, that the recovery processing has been executed and that the recovery processing has succeeded.

2. The information processing system according to claim 1, wherein
the processor records, in the storage unit via the controller software, the information indicating that the recovery processing is to be executed, and then executes restart of the system.

3. The information processing system according to claim 2, wherein
when the activation of the system immediately before the falsification of the firmware installed in the functional device is detected is an activation through power-on of the system, the processor executes restart of the system.

4. The information processing system according to claim 2, wherein
when the activation of the system immediately before the falsification of the firmware installed in the functional device is detected is an activation through a return of the system from a power saving state, the processor notifies a user of restart of the system and executes the restart of the system in response to an instruction from the user.

5. The information processing system according to claim 1, wherein
the processor executes restart of the system after executing the recovery processing.

6. The information processing system according to claim 1, wherein
the processor activates the controller software after restart of the system after executing the recovery processing, and when the falsification of the firmware installed in the functional device has been detected and the information indicating that the recovery processing is to be executed has been recorded in the storage unit, records, in a log via the controller software, that the recovery processing has been executed and that the recovery processing has failed.

7. The information processing system according to claim 6, wherein
the processor records, in the log, that the recovery processing has been executed and that the recovery processing has failed, and then executes the recovery processing again.

8. A non-transitory computer-readable storage medium storing a program causing a computer to execute processing comprising:
recording information in a storage unit via controller software for controlling a functional device and recording a log related to the functional device when a falsification of firmware installed in the functional device is detected in a state where the controller software has been activated, the information indicating that recovery processing for reinstalling the firmware in the functional device is to be executed;
activating installer software for performing the recovery processing in a state where the controller software is not activated and executes the recovery processing via the installer software; and
activating the controller software after executing the recovery processing, and when the firmware of the functional device is normal and the information indicating that the recovery processing is to be executed has been recorded in the storage unit, recording, in a log, via the controller software, that the recovery processing has been executed and that the recovery processing has succeeded.
